(19) United States
(12) Patent Application Publication
(10) Pub. No.: US 2025/0355435 A1
(43) Pub. Date: Nov. 20, 2025

(54) SYSTEM AND METHOD FOR AUTOMATED VALET PARKING OR AUTOMATED FACTORY DRIVING

(71) Applicant: Ford Global Technologies, LLC, Dearborn, MI (US)

(72) Inventor: Stefan Jenzowsky, Adelsdorf (DE)

(73) Assignee: Ford Global Technologies, LLC, Dearborn, MI (US)

(21) Appl. No.: 19/208,181

(22) Filed: May 14, 2025

(30) Foreign Application Priority Data
May 14, 2024 (DE) 10 2024 113 436.4

(51) Int. Cl. G05D 1/225; B60W 30/06; G05D 107/70

(52) U.S. Cl. CPC G05D 1/225; B60W 30/06; B60W 2556/40; B60W 2556/45; G05D 2107/70

(57) ABSTRACT

An automated valet parking or automated factory driving system, or for the remote control of vehicles in logistics, includes a sensor infrastructure that captures with pre-installed sensors an operating area, a central control unit that receives infrastructure sensor data and is in communication with an engine control unit (ECU) of one or more vehicles to be remotely controlled, and to receive vehicle sensor data from a connected vehicle, and to generate one or more paths for the remote control of the vehicles, and to remotely control the vehicles. Vehicle sensor data generated for objects with a size that is below a predetermined cutoff size is used, while, in particular, vehicle sensor data generated for objects with a size that is above the predetermined cutoff size is not taken into account when planning one or more paths.

### CROSS-REFERENCE TO RELATED APPLICATION

This application claims priority to and the benefit of German Application No. 102024113436.4, filed on May 14, 2024. The disclosure of the above application is incorporated herein by reference.

### FIELD

The disclosure relates to a system and a method for automated valet parking (AVP) or automated factory driving (AFD).

### BACKGROUND

The statements in this section merely provide background information related to the present disclosure and may not constitute prior art.

AVP systems provide steering of vehicles to a parking lot and back to a staging point by automatic means and without human intervention. Automated Factory Driving (AFD) relates to driverless control in car manufacturers' factories and is therefore very similar to AVP, differing essentially in the type of environment and the destination points to be reached.

Unless there are explicit changes, the following statements on the AVP also apply analogously to AFD.

Within AVP, a total of three levels referred to as AVP1, AVP2 and AVP3 are distinguished. In AVP1, the sensors and control logic and electronics are located exclusively in the respective vehicle, which independently searches for its way to a parking space. This applies to production (AFP) as well as to logistics and parking (the actual AVP). AVP1 is based exclusively on sensors attached to the vehicle, which means that this AVP level is associated with high equipment requirements for the participating vehicles.

AVP Level 2 (AVP2) represents the reverse case, in which the autonomous guidance of vehicles in production, logistics and parking is implemented by an external system that has externally installed sensors that monitor the area in which the vehicle is to be remotely controlled, while none of the sensors installed on the vehicle are used for support. This also means that the equipment of the participating vehicles does not have to be as extensive as in the case of AVP1.

The external sensors used in such systems for AVP2 are relevant for providing for operational information

Unlike in the case of AVP1, where the vehicle drives autonomously, in AVP2 the vehicle must be controlled remotely. This means that an external system must have access to the vehicle's engine control unit (ECU, “Electronic Control Unit”). This is usually the case with modern vehicles whose engine control unit contains a 4G or 5G communication interface for mobile data, whereby the engine control unit itself has access to the vehicle's sensor data and to the main control-relevant components of the system such as the engine, steering and braking. The applicant has interfaces for various manufacturers with which external control commands can be transferred to the vehicle, causing the vehicle to follow a path generated by the external system.

A next stage of development is AVP3, which is defined in such a way that sensor data from a mixed sensor system consisting of both external sensors installed in the infrastructure and sensors installed on the vehicle to be controlled are combined. AVP3, too, can be used in production and logistics as well as in parking. The generating logic remains with the external system. AVP3 also does not require any expansion of the vehicle sensor system beyond the vehicle sensors installed as standard.

AVP Level 3 has not yet been implemented, partly because the sensors installed in vehicles do not yet meet the increased operational requirements for remote or autonomous vehicle control, whereas the external sensors installed in AVP2 systems can provide that the operational requirements are met.

### SUMMARY

This section provides a general summary of the disclosure and is not a comprehensive disclosure of its full scope or all of its features.

The present disclosure is therefore based on the task of providing systems and methods that go beyond AVP Level 2 to provide remote control of vehicles in the context of production (AFD), logistics and parking (AVP).

A system for Automated Valet Parking or Automated Factory Driving, or for the remote control of vehicles in logistics, comprises a sensor infrastructure which captures an operating area with pre-installed sensors, which is intended to remotely control one or more vehicles therein, a central control unit which receives infrastructure sensor data from the sensor infrastructure and is designed to establish and maintain a connection via one or more interfaces with an engine control unit (ECU) of one or more vehicles to be remotely controlled, and receiving vehicle sensor data from a connected vehicle and generating one or more paths for remotely controlling the one or more vehicles taking into account the vehicle sensor data and remotely controlling the one or more vehicles along the one or more paths, using vehicle sensor data which have been generated for objects having a size which is below a predetermined cutoff size, while, in particular, vehicle sensor data generated for objects having a size which is above the predetermined cutoff size are not taken into account when generating the one or more paths.

Features of the enhanced system is at least twofold. Firstly, compared to an AVP2 system, which does not use any vehicle sensor data at all, additional vehicle sensor data is used so that a more forward image of the surroundings of the vehicle to be remotely controlled is available generating one or more paths than in the case of AVP2. Secondly, operation of the system can be enhanced because a limit value for the size of objects is predefined, meaning the vehicle sensor data of the non-standardized vehicle sensors are no longer taken into account during path generation.

The cutoff size is preferably in the range of 30 to 50 cm, in particular 40 cm, or is set depending on specific requirements. Below this cutoff size, the vehicle sensor data, for example LIDAR (Light Detection and Ranging) data, can be used. This also means that smaller objects, which may not be detected by the fixed infrastructure sensors but still represent an obstacle for the vehicle in question, can now be detected, which was not possible with a previous AVP2 system

When determining the cutoff size depending on system requirements, it can play a role which types of sensors are actually used, whereby, in order to comply with the requirements, the cutoff size is chosen to be smaller if the accuracy of the vehicle sensors used is comparatively low, or which type the operating area is.

It is technically possible to transmit vehicle sensor data to the external AVP system because the sensor data is already available in the vehicle's engine control unit, meaning that an AVP interface to the engine control unit can be adapted so that vehicle sensor data can also be transmitted to the external AVP system.

The size of the object can either be detected in the vehicle or in the central control unit. Object detection and object size detection based on video images and/or LIDAR measurement data can either already be implemented in the control electronics of a vehicle, or the raw data is evaluated in the central control unit of the external system, which has the desired detection architecture.

In one variation of the system, the infrastructure sensor data is only taken into account when generating the path or paths in relation to objects that have a size that is above the cutoff size. This complete separation and case differentiation between small and large objects has the advantage that the number or density of external infrastructure sensors can be reduced, as these are now only used for the larger objects, which can be detected with a greater detection reliability than small objects anyway. In this way, the entire AVP system can be set up more efficiently.

A system for Automated Valet Parking or Automated Factory Driving, or for remote control of vehicles in logistics are provided, in particular according to variations of the system described above, wherein the system comprises a surveillance camera infrastructure which captures with pre-installed surveillance cameras an operating area, which is intended to remotely control one or more vehicles therein, a central control unit which receives images from the surveillance cameras of the surveillance camera infrastructure and is designed to establish and maintain a connection with an engine control unit (ECU) of one or more vehicles to be remotely controlled via one or more interfaces, and to receive vehicle sensor data from a connected vehicle and to generate one or more paths for the remote control of the one or more vehicles, taking into account the vehicle sensor data, and to remotely control the one or more vehicles along the one or more paths, the vehicle sensor data originating from vehicle sensors with an ASIL-B level, wherein, in particular in this case, vehicle sensor data generated for objects which have a size which is above the predetermined cutoff size are also taken into account in the generation of the one or more paths.

In this case, low-image resolution surveillance camera images are used to detect objects and the ASIL-B-certified detectors are also used for larger objects in addition to small objects. This system is also easier to produce, as no certified external sensors are required.

In an additional further development, which can be applied to any of the systems described above, it may be provided that at least one video stream from at least one video camera installed in the vehicle is also transmitted to the external system and taken into account by the central control unit during path generation. The video data can be used, for example, for object recognition, recognition of persons in the field of vision of the video camera installed in the vehicle and for recognizing free parking spaces.

In another further development, it may be provided that the central control unit of the external system responsible for path generation is designed to contact other vehicles parked in the operating area and to initialize and retrieve their sensor data and/or video streams. In this way, coverage of the monitored area can be achieved. The external system has knowledge of the locations of the various vehicles, which it either receives via external sensors in the infrastructure or has retained from previous remote control operations. Especially if these other vehicles are parked at right angles or at an angle to the road, their vehicle sensors have coverage of the area to be monitored and their sensor and possibly video data can be used to guide another vehicle. This leads to greater redundancy in the sensor system and therefore to increase performance when steering the vehicle that is following the currently detected path.

The central path generation in this system can be carried out using an artificial model (machine learning model) trained for this purpose, which may have access to a map of the operating area. Alternatively, path generation can also be carried out with conventional algorithms using a map of the operating area.

A method for automated valet parking or automated factory driving, or for remote control of vehicles in logistics is provided, in which pre-installed sensors of a sensor infrastructure capture an operating area intended to remotely control one or more vehicles therein, wherein a central control unit of the system receives the infrastructure sensor data from the sensor infrastructure and establishes and maintains a connection via one or more interfaces with an engine control unit (ECU) of one or more vehicles to be remotely controlled, and receives vehicle sensor data from a connected vehicle and generates one or more paths for the remote control of the one or more vehicles taking into account the vehicle sensor data and remotely controls the one or more vehicles along the one or more paths, wherein the central control unit uses vehicle sensor data in the path generation, which have been generated for objects which have a size which is below a predetermined cutoff size, while in particular it does not take into account vehicle sensor data which have been generated for objects which have a size which is above the predetermined cutoff size when generating the one or more paths.

This method realizes the same properties, features and advantages as the previously described system according to the disclosure.

Alternatively, in a method for automated valet parking or automated factory driving, or for the remote control of vehicles in logistics, which is designed in particular according to a variation of the method described above, an operating area is captured with pre-installed surveillance cameras of a surveillance camera infrastructure, which is intended to remotely control one or more vehicles therein, wherein a central control unit receives one or more images from the surveillance cameras of the surveillance camera infrastructure, identifies one or more vehicles in the one or more images, and establishes and maintains connection via one or more interfaces with an engine control unit of one or more vehicles to be remotely controlled, and receives vehicle sensor data from a connected vehicle and generates one or more paths for the remote control of the one or more vehicles taking into account the vehicle sensor data and remotely controls the one or more vehicles along the one or more paths, wherein the vehicle sensor data originates from vehicle sensors with an ASIL-B level. In variations, in this case, vehicle sensor data generated for objects having a size above the predetermined cutoff size are also taken into account when generating the one or more paths.

This method realizes the same properties, features and advantages as the alternative system according to the disclosure described above.

In an additional further development, which can be applied to any of the methods described above, at least one video stream from at least one video camera installed in the vehicle is also transmitted to the external system and taken into account by the central control unit during path generation. The video data can be used, for example, for object recognition, recognition of persons in the field of view of the video camera installed in the vehicle and for recognizing free parking spaces.

In another further development, the central control unit tasked with the path generation may contact other vehicles parked in the operating area and initialize and retrieve/receive their sensor data and/or video streams and take them into account in the path generation. In this way, good and also multiple coverage of the monitored area can be achieved. The external system has knowledge of the locations of the various vehicles, which it either receives from external sensors in the infrastructure or has retained from previous remote control processes.

A software program product with program code means are also provided which, when executed on the central control unit of a system according to the disclosure, carry out a method according to the disclosure.

Further areas of applicability will become apparent from the description provided herein. It should be understood that the description and specific examples are intended for purposes of illustration only and are not intended to limit the scope of the present disclosure.

Further features of the disclosure will become apparent from the description of variations according to the disclosure together with the claims and the accompanying drawings. Variations according to the disclosure may fulfill individual features or a combination of several features.

In the context of the disclosure, features marked “in particular” or “preferably” are to be understood as optional features.

The disclosure is described below, without limiting the general idea of the disclosure, by means of examples of variations with reference to the drawings, with express reference being made to the drawings with regard to all details according to the disclosure that are not explained in more detail in the text.

### DRAWINGS

In order that the disclosure may be well understood, there will now be described various forms thereof, given by way of example, reference being made to the accompanying drawings, in which:

FIG. 1A schematic representation of how an AVP system works according to the prior art;

FIG. 2 a schematic representation of a variation of a system according to the disclosure; and

FIG. 3 a schematic representation of a further variation of a system according to the disclosure.

In the drawings, the same or similar elements and/or parts are provided with the same reference numbers, so that they are not presented again.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

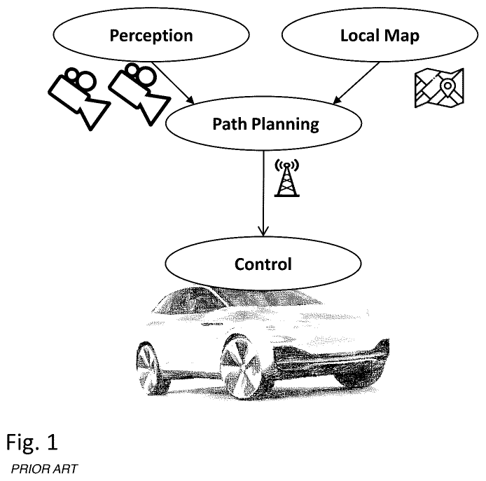

FIG. 1 shows a schematic diagram of how an AVP system works. The system comprises a central unit that carries out path generation for one or more vehicles in an operating area, for example to automatically drive the vehicle from a transfer point to a parking space in a parking garage, a multi-story parking lot or an open parking area, from a starting point to an end point in a production hall, to or in a parking lot of an automobile factory or to a loading station.

The central unit receives input from external cameras that monitor the operating area (“Perception”) and from a stored map of the operating area (“Local Map”), which contains, for example, parking areas, individual parking bays and lanes as well as their positions and dimensions. The paths created in this way are transmitted via a wireless connection, for example a 4G or 5G mobile connection, to a control unit of the vehicle, for example an engine control unit (ECU), which then automatically steers the car along the specified path.

The external cameras and any other sensors not shown are certified to meet predetermined specifications. As soon as the system detects that an obstacle is on the path in front of the vehicle, the central unit instructs the vehicle to stop. If desired, the path is recalculated to go around the obstacle.

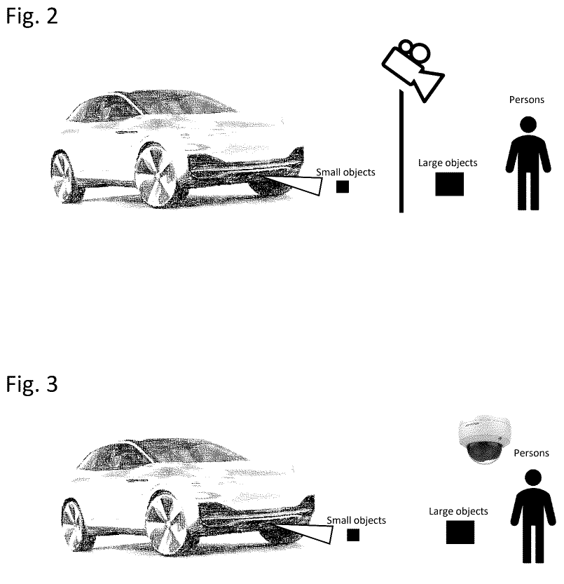

FIG. 2 shows a first example of a system according to the disclosure. Path generation is still the responsibility of a central unit as shown in FIG. 1, which is no longer shown in FIG. 2, and which sends control commands to the vehicle's control unit. In this case, vehicle sensor data from the vehicle is also used, for example, one or more video streams from one or more vehicle cameras, or sensor data from radar or lidar sensor units, which are sent from the vehicle to the central unit shown in FIG. 1 for this purpose.

Since these vehicle sensors are not necessarily certified, a case distinction is made in this variation. The addition of vehicle sensor data for small objects or obstacles in path calculation and tracking therefore increases the performance of the system.

A cutoff size in one example is approximately 40 cm, but can also be a value slightly below or above this, possibly variable depending on specific requirements, which may differ according to the type of operating area, speed of the vehicle, level of redundancy of the sensor coverage, degree of certification of the vehicle sensors or the external sensors, or other factors.

FIG. 3 shows another example of a system according to the disclosure, in which larger objects or obstacles are again detected by an external sensor system and used in path calculation and tracking, with vehicle sensor data also being sent to the central unit for path generation. In this exemplary variation, the vehicle has certified ASIL-B level vehicle sensors

As the vehicle itself already has a sufficiently high certification level, the requirements for the system's external sensors are lower. Here, for example, it is sufficient to use the video streams from the surveillance cameras installed in a parking garage anyway, which have a comparatively low resolution for path generating, where smaller objects would hardly be recognizable. In this case, the lower sensitivity of the external system is compensated for by the fact that the vehicle sensors, whose sensor data is transmitted to the central unit and processed there, meet a sufficiently high security standard.

All the features mentioned, including those to be taken from the drawings alone as well as individual features disclosed in combination with other features, are regarded as desirable to the disclosure, both alone and in combination. Variations according to the disclosure can be fulfilled by individual features or a combination of several features

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

In this application, the term “controller” and/or “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The term memory is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general-purpose computer to execute one or more particular functions embodied in computer programs. The functional blocks, flowchart components, and other elements described above serve as software specifications, which can be translated into the computer programs by the routine work of a skilled technician or programmer.

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A system for remote control of one or more vehicles, the system comprising:
a sensor infrastructure, the sensor infrastructure comprising:
pre-installed sensors in an operating area, wherein the pre-installed sensors are configured to remotely control the one or more vehicles within the operating area; and
a central control unit configured to:
receive infrastructure sensor data from the sensor infrastructure;
identify the one or more vehicles based upon the infrastructure sensor data;
establish and maintain a connection, via one or more interfaces, with one or more engine control units (ECU) of the one or more vehicles to be remotely controlled, thereby creating one or more connected vehicles;
receive vehicle sensor data from the one or more connected vehicles;
generate one or more paths for remotely controlling the one or more connected vehicles, wherein the one or more paths are based upon the vehicle sensor data corresponding to objects having a size greater than a predetermined cutoff size; and
remotely control the one or more connected vehicles along the one or more paths.

2. The system of claim 1, wherein the vehicle sensor data is received from one or more vehicle sensors with an ASIL-B level.

3. The system of claim 1, wherein the predetermined cutoff size is between 30 and 50 cm.

4. The system of claim 1, wherein the central control unit is further configured to determine a size of each of the objects.

5. The system of claim 1, wherein the central control unit is further configured to receive a map of the operating area, and wherein generating one or more paths comprises utilizing a machine learning model configured to receive the map of the operating area and the vehicle sensor data and generate the one or more paths.

6. The system of claim 1, wherein the one or more paths are further based upon infrastructure sensor data corresponding to objects having a size greater than the predetermined cutoff size.

7. A system for remote control of one or more vehicles, the system comprising:
one or more surveillance cameras configured to capture images of an operating area; and
a central control unit configured to:
receive one or more images from the one or more surveillance cameras;
identify one or more vehicles in the one or more images;
establish and maintain a connection, via one or more interfaces, with one or more engine control units (ECU) of the one or more vehicles;
receive vehicle sensor data from the one or more vehicles;
generate one or more paths based on the vehicle sensor data; and
remotely control the one or more vehicles along the one or more paths.

8. The system of claim 7, wherein the vehicle sensor data is received from one or more vehicle sensors with an ASIL-B level.

9. The system of claim 7, wherein the vehicle sensor data comprises vehicle sensor data corresponding to objects having a size above a predetermined cutoff size.

10. The system of claim 7, wherein the one or more surveillance cameras are configured to generate one or more video streams, wherein the one or more video streams are transmitted to the central control unit, and wherein generating one or more paths is additionally based upon the one or more video streams.

11. The system of claim 7, wherein the central control unit is further configured to:
establish connections with one or more vehicles; and
initialize and receive sensor data and/or video streams from the one or more vehicles.

12. The system of claim 7, wherein the central control unit is further configured to receive a map of the operating area.

13. The system of claim 12, wherein generating one or more paths comprises utilizing a machine learning model configured to receive the map of the operating area and the vehicle sensor data and generate the one or more paths.

14. A method for remote control of one or more vehicles, the method comprising:
receiving sensor data from one or more sensors installed in an operating area;
identifying a vehicle of the one or more vehicles corresponding to the sensor data, thereby generating an identified vehicle;
establishing and maintaining, via one or more interfaces with an engine control unit (ECU) of the identified vehicle, a connection with the identified vehicle;
receiving vehicle sensor data from the identified vehicle;
generating one or more paths based upon the vehicle sensor data, wherein generating the one or more paths is based on vehicle sensor data corresponding to objects with a size below a predetermined cutoff size.

15. The method of claim 14, wherein the vehicle sensor data is received from one or more vehicle sensors with an ASIL-B level.

16. The method of claim 14, wherein the one or more sensors comprise one or more surveillance cameras, wherein the sensor data comprises one or more images, wherein the method of performed by a central control unit additionally configured to remotely control the vehicle along the one or more paths.

17. The method of claim 14, wherein generating the one or more paths is further based on vehicle sensor data corresponding to objects having a size above the predetermined cutoff size.

18. The method of claim 14, wherein the method further comprises receiving one or more video streams from one or more one video cameras installed in the identified vehicle, and wherein generating one or more paths is additionally based upon the one or more video streams.

19. The method of claim 14, further comprising receiving a map of the operating area, and wherein generating one or more paths comprises utilizing a machine learning model configured to receive the map of the operating area and the vehicle sensor data and generate the one or more paths.

20. The method of claim 14, wherein the vehicle comprises a plurality of vehicles, and wherein the identified vehicle comprises a plurality of identified vehicles.
